(19) United States
(12) Patent Application Publication
(10) Pub. No.: US 2017/0244856 A1
(43) Pub. Date: Aug. 24, 2017

(54) INFORMATION PROCESSING APPARATUS AND NON-TRANSITORY COMPUTER-READABLE PROGRAM

(71) Applicant: FUJI XEROX CO., LTD., Tokyo (JP)

(72) Inventors: Kazuhiko NARUSHIMA, Yokohama-shi (JP); Koichi AZUMA, Yokohama-shi (JP); Hidenori HORIE, Yokohama-shi (JP); Kenji KUROISHI, Yokohama-shi (JP); Masafumi ONO, Yokohama-shi (JP)

(73) Assignee: FUJI XEROX CO., LTD., Tokyo (JP)

(21) Appl. No.: 15/226,289

(22) Filed: Aug. 2, 2016

(30) Foreign Application Priority Data
Feb. 19, 2016 (JP) 2016-029724

(51) Int. Cl. H04N 1/00; G06F 1/32; G06F 3/12

(52) U.S. Cl. CPC H04N 1/00896; H04N 1/00891; H04N 1/00411; G06F 3/1211; G06F 1/3231; H04N 2201/0094

(57) ABSTRACT

An information processing apparatus includes a communication unit that receives supply of electric power and performs communication with a storage device used to store data, a supply controller that controls supply of electric power in an own apparatus according to a plurality of modes including a first mode and a second mode in which power consumption is smaller than that of the first mode, and transitions from the second mode to the first mode, a receiving unit that receives instruction to execute process based on the data from a user after the transition from the second mode to the first mode, an acquiring unit that requests acquisition of the data to the storage device and acquires the data according to the request based on the instruction, and an execution unit that executes a process based on the acquired data.

### CROSS-REFERENCE TO RELATED APPLICATIONS

This application is based on and claims priority under 35 USC 119 from Japanese Patent Application No. 2016-029724 filed on Feb. 19, 2016.

### BACKGROUND

### 1. Technical Field

The present invention relates to an information processing apparatus and a program.

### SUMMARY

An aspect of the invention provides an information processing apparatus including: a communication unit that receives supply of electric power and performs communication with a storage device through a communication line, the storage device being used to store data; a supply controller that controls supply of electric power in an own apparatus according to a plurality of modes including a first mode and a second mode in which power consumption is smaller than that of the first mode, and transitions from the second mode, in which the supply of electric power to the communication unit is interrupted, to the first mode in which electric power is supplied to the communication unit; a receiving unit that receives instruction to execute process based on the data from a user after the transition from the second mode to the first mode; an acquiring unit that requests acquisition of the data to the storage device and acquires the data according to the request based on the instruction; and an execution unit that executes a process based on the acquired data.

### BRIEF DESCRIPTION OF THE DRAWINGS

Exemplary embodiments of the present invention will be described in detail based on the following figures, wherein:

FIG. 1 is a perspective view illustrating an outer configuration of an image forming apparatus according to an exemplary embodiment of the invention;

FIG. 2 is a block diagram illustrating a hardware configuration of the image forming apparatus;

FIG. 3 is a diagram illustrating a range in which the presence of a person is detected by the image forming apparatus;

FIG. 4 is a sequence chart illustrating a process executed by the image forming apparatus;

FIGS. 5A to 5C are diagrams illustrating the change in the position of a person present around the image forming apparatus; and

FIG. 6 is a diagram illustrating the change in the position of a person present around the image forming apparatus.

### DETAILED DESCRIPTION

An exemplary embodiment of the invention will be described with reference to the accompanying drawings. Hereinafter, the description will be made with respect to a case in which an information processing apparatus of the invention is applied to an image forming apparatus.

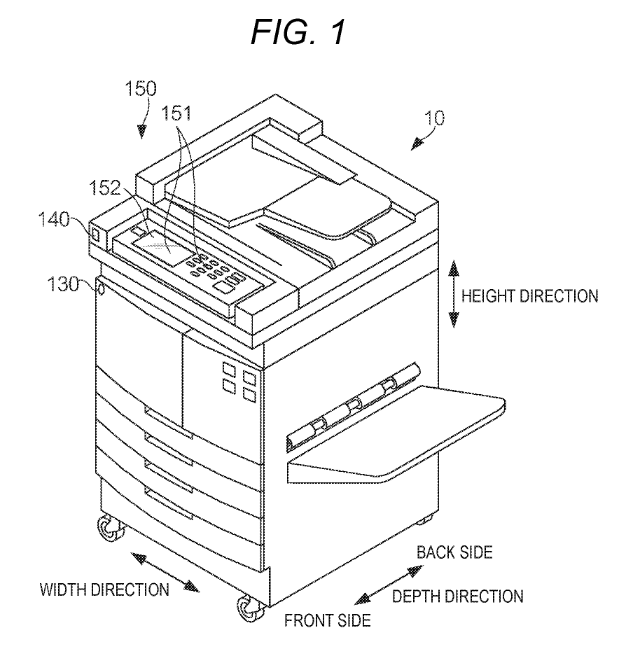

FIG. 1 is a perspective view illustrating an outer configuration of an image forming apparatus 10 according to an exemplary embodiment of the invention. As illustrated in FIG. 1, the image forming apparatus 10 is a console-type image forming apparatus. The image forming apparatus 10 has a function of accessing a storage location instructed by a user to acquire image data and executing a process of forming an image on a medium such as a sheet based on the image data (hereinafter, referred to as an “image forming process”). That is, the image forming apparatus 10 has a function of performing a so-called pull print. The user of the image forming apparatus 10 uses a user interface 150 while standing in front of the image forming apparatus 10. Specifically, the user operates an operating unit 151 or views an image on a display 152.

The image forming apparatus 10 includes a pyroelectric sensor 130 and a reflection sensor 140 as a configuration for detecting the presence of a person present on the front side thereof. The pyroelectric sensor 130 and the reflection sensor 140 are provided to detect the presence of a person who is likely to use the image forming apparatus 10.

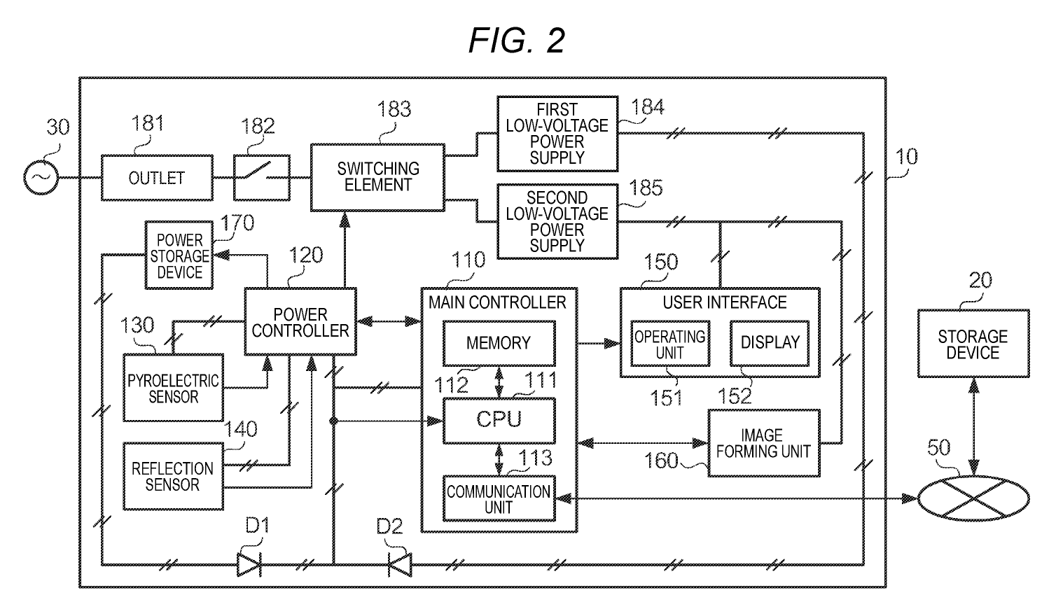

FIG. 2 is a block diagram illustrating a hardware configuration of the image forming apparatus 10. As illustrated in FIG. 2, the image forming apparatus 10 includes a main controller 110, a power controller 120, the pyroelectric sensor 130, the reflection sensor 140, the user interface 150, an image forming unit 160, a power storage device 170, an outlet 181, a main switch 182, a switching element 183, a first low-voltage power supply 184, and a second low-voltage power supply 185. In FIG. 2, arrows indicated by solid lines connecting blocks indicate the flow of signals and solid lines without arrows indicate the flow (power supplying wires) of electric power.

The main controller 110 includes a central processing unit (CPU) 111, a memory 112, and a communication unit 113. The memory 112 includes a read only memory (ROM) and a random access memory (RAM), for instance. The CPU 111 controls the respective units of the image forming apparatus 10 by reading a program stored in the ROM of the memory 112 or an auxiliary storage device (for instance, a hard disk drive) (not illustrated) into the RAM of the memory 112 and executing the program. The communication unit 113 includes a modem, for instance, and performs communication via a communication line 50 (the communication unit 113 is an instance of a communication unit). The communication unit 113 communicates with a storage device 20 connected to the communication line 50. The communication line 50 is a public communication line (communication network) such as the Internet.

The storage device 20 is a device that stores image data used for an image forming process. The image data is, for instance, data of the page description language (PDL) format, but may be other formats of data. The storage device 20 is a device such as a person computer (PC) used by an individual. In this case, the storage device 20 stores image data managed (owned) by the individual. The storage device 20 may be a device (for instance, a server apparatus or an image forming apparatus) that stores the image data managed by each of plural persons.

The power controller 120 includes an application specific integrated circuit (ASIC), for instance, and control a power supply to the respective units of the image forming apparatus 10. The power controller 120 is an instance of a supply controller, controls the supply of electric power in the image forming apparatus 10 according to plural modes. The power controller 120 may be mounted in the main controller 110. In the present exemplary embodiment, the mode includes a “process execution mode,” a “standby mode,” a “sleep mode,” and a “sleep-zero mode”. The power consumption (power consumption amount) of the image forming apparatus 10 increases in the order of “process execution mode”>“standby mode”>“sleep mode”>“sleep-zero mode”. In other words, in the image forming apparatus 10, the number of hardware circuits of which a part or all of the functions is stopped increases in the order of “sleep-zero mode”>“sleep mode”>“standby mode”>“process execution mode”. The details of the respective modes will be described later.

The pyroelectric sensor 130 is a passive infrared human detection sensor having a pyroelectric element. The reflection sensor 140 is an infrared sensor in this instance and is configured such that a photodetector detects reflected light which is emitted from an emitter and is reflected from the surface of an object (that is, a person). It is assumed that the reflection sensor 140 consumes a larger amount of power than the pyroelectric sensor 130.

The pyroelectric sensor 130 is an instance of a first detector and the reflection sensor 140 is an instance of a second detector.

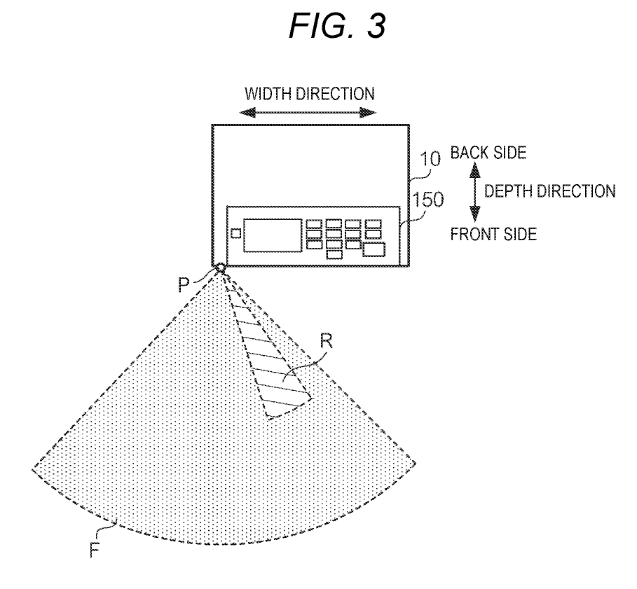

FIG. 3 is a diagram illustrating a range in which the presence of a person is detected by the image forming apparatus 10. In FIG. 3, the image forming apparatus 10 and the surrounding are seen from above in the height direction of the image forming apparatus 10.

As illustrated in FIG. 3, a first detection range F of the pyroelectric sensor 130 is formed on the front side of the image forming apparatus 10 and is approximately fan-shaped. When a person approaches the image forming apparatus 10 or the person passes across the image forming apparatus 10, the person may enter into the first detection range F. The first detection range F is an instance of the range of “first distance” from the image forming apparatus 10. In this instance, a position which is indicated by a symbol “P” in FIG. 3 and in which the pyroelectric sensor 130 is disposed will be regarded as the position of the image forming apparatus 10.

A second detection range R illustrated in FIG. 3 is formed on the front side of the image forming apparatus 10 and is approximately triangular. The second detection range R is entirely included in the first detection range F and the angle of a corner including the apex located at the position P is smaller than that of the first detection range F. The second detection range R is an instance of the range of “second distance” from the image forming apparatus 10 and is the range of distance closer to the image forming apparatus 10 than the first detection range F. A person who uses the image forming apparatus 10 enters into the second detection range R.

The description will be continued by returning to FIG. 2.

The user interface 150 is a means for realizing interaction with users and includes the operating unit 151 that receives operations input by users and the display 152 that displays images. The operating unit 151 includes an operator such as a physical key or a touch sensor (for instance, a resistive film-type or electrostatic capacitance-type touch sensor). The operating unit 151 receives an instruction to execute an image forming process according to an operation of a user (the operating unit 151 is an instance of a receiving unit). The display 152 includes a liquid crystal panel and a liquid crystal driving circuit, for instance. The display 152 displays an image for receiving user's operations including the instruction to execute the image forming process (the display 152 is an instance of a display).

The image forming unit 160 executes the image forming process based on the image data (the image forming unit 160 is an instance of an execution unit). The image forming unit 160 may form an image on a medium, using an electrographic manner, more specifically, forming a latent image by irradiating laser beams to an image holding body, such as a photoreceptor, transferring the latent image on the medium, such as a record sheet, by developing the latent image using toners having respective colors, such as Yellow (Y), Magenta (M), Cyan (C), and black (K), and discharging the medium through a fixing process.

The power storage device 170 has the function of a battery that stores electric power (the power storage device 170 is an instance of a first power supply). In the sleep-zero mode, the power storage device 170 is connected to a rectifying element D1 via a power supplying wire to supply electric power to the power controller 120, a portion of the main controller 110, and the pyroelectric sensor 130. Although not illustrated in the drawing, the power storage device is configured to be able to be charged by a low-voltage power supply or the like.

The image forming apparatus 10 receives electric power from a commercial power supply 30 by being connected to the commercial power supply 30 via the outlet 181. The outlet 181 is connected to one end of the main switch 182. The other end of the main switch 182 is connected to the first low-voltage power supply 184 and the second low-voltage power supply 185 via the switching element 183. The switching element 183 is configured as a semiconductor element such as a triac and switches the connection (that is, a power supply path) between the commercial power supply 30 and each of the first low-voltage power supply 184 and the second low-voltage power supply 185.

The switching element 183 is configured to switch the connection to the commercial power supply 30, independently of the first low-voltage power supply 184 and the second low-voltage power supply 185.

The first low-voltage power supply 184 supplies electric power (for instance, a power-supply potential of 5 V) to components to which the supply of electric power is not to be stopped in the sleep mode, such as the main controller 110, the power controller 120, the reflection sensor 140, and the pyroelectric sensor 130, based on the commercial power supply 30. The second low-voltage power supply 185 supplies electric power (for instance, a power supply potential of 24 V and 5 V) to the user interface 150 and the image forming unit 160 based on the commercial power supply 30, and the first low-voltage power supply 184 and the second low-voltage power supply 185 are instances of a second power supply.

In order to heat a heater (for instance, a halogen lamp or an IH heater) used in the fixing device of the image forming unit 160, the power supply of 100 V may be used. Although the description there of is not presented in this exemplary embodiment, such a power supply may be provided separately from the first low-voltage power supply 184 and the second low-voltage power supply 185.

The image forming apparatus 10 may further include constituent elements equivalent to those of a general image forming apparatus, such as an image reading unit for reading an image of an original document or the like and a facsimile communication unit for performing facsimile communication in addition to the above-described constituent elements.

In the image forming apparatus 10 having such a configuration, the “process execution mode” is a mode in which the image forming apparatus 10 executes processing (for instance, an image forming process). In the “process execution mode”, electric power is supplied to all hardware circuits described in FIG. 2. In the “standby mode”, electric power is supplied to all hardware circuits described in FIG. 2 similarly to the “process execution mode” (the “standby mode” is an instance of a first mode). However, since processing is not being executed, it is assumed that the power consumed by the image forming apparatus 10 is smaller than that in the “process execution mode”. In the “process execution mode” and the “standby mode”, the first and second low-voltage power supplies 184 and 185 supply electric power. On the other hand, it is assumed that the supply of electric power from the power storage device 170 is interrupted (stopped).

The “sleep mode” is a mode (an instance of a third mode) in which the first low-voltage power supply 184 supplies electric power to the power controller 120, a portion of the main controller 110, the pyroelectric sensor 130, and the reflection sensor 140 and the supply of electric power from the second low-voltage power supply 185 is interrupted. In other words, in the sleep mode, although the power controller 120, a portion of the main controller 110, the pyroelectric sensor 130, and the reflection sensor 140 are operating, the other hardware circuits illustrated in FIG. 2 are not operating. For instance, the communication unit 113 suspends a monitoring function of monitoring the communication line 50 and does not transmit and receive data via the communication line 50. Moreover, it is assumed that the supply of electric power from the power storage device 170 is interrupted. Although not illustrated in the drawing, a main power supply unit can save electricity consumed in the apparatus.

The “sleep-zero mode” is a mode (an instance of a second mode) in which the supply of electric power from the first low-voltage power supply 184 and the second low-voltage power supply 185 is interrupted. In the sleep-zero mode, the power storage device 170 supplies electric power to the power controller 120 and the pyroelectric sensor 130. In other words, in the sleep-zero mode, although the power controller 120 and the pyroelectric sensor 130 are operating, the other hardware circuits illustrated in FIG. 2 are not operating. The communication unit 113 stops the monitoring function of the communication line 50.

In the “sleep mode” and the “sleep-zero mode,” at least the function of the power controller 120 switching the switching element 183 may be operating, and all functions may not need to be operating. Moreover, the switching function of the power controller 120 may be separated as an independent functional unit.

Next, the operation of the present exemplary embodiment will be described.

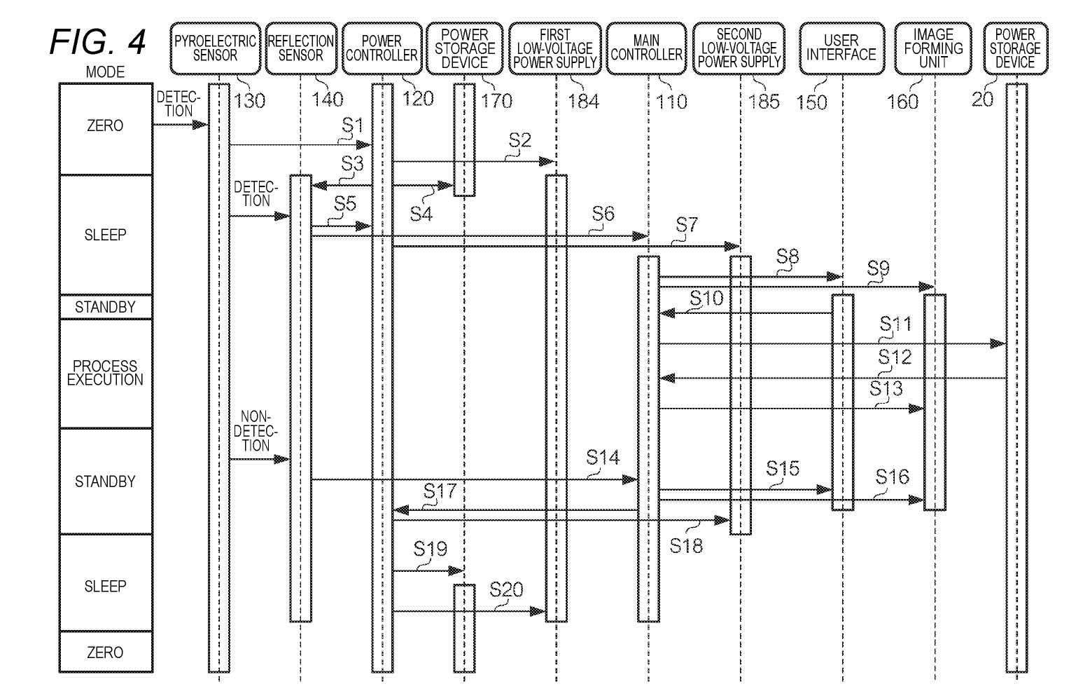

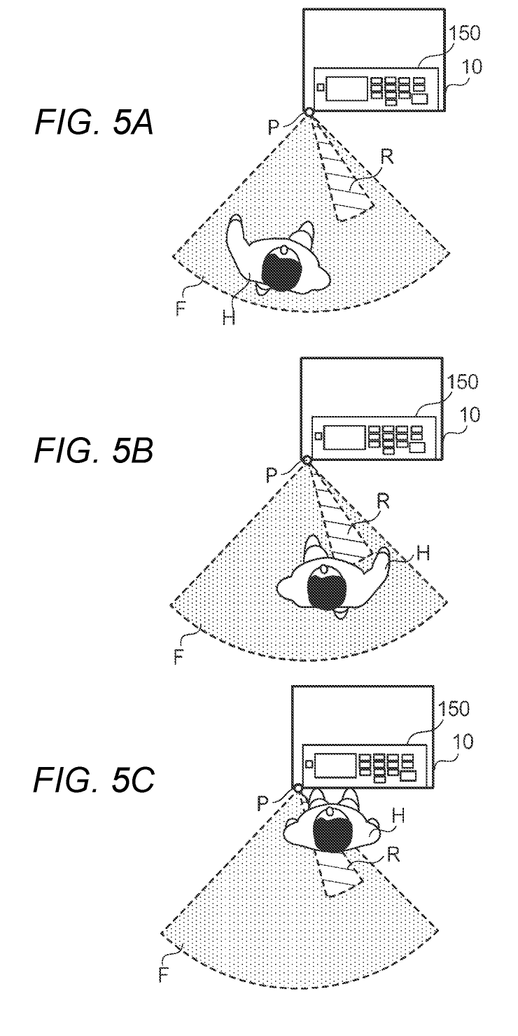

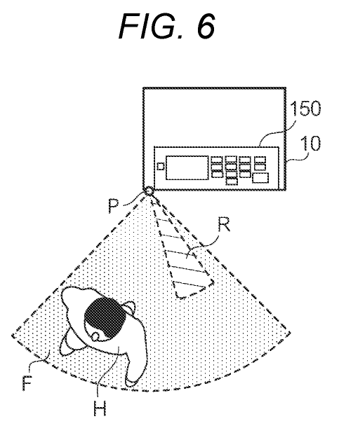

FIG. 4 is a sequence chart illustrating the process executed by the image forming apparatus 10. FIG. 4 also illustrates a temporal change in the mode of the image forming apparatus 10. FIGS. 5A to 5C and FIG. 6 are diagrams illustrating the change in the position of a person present around the image forming apparatus 10.

As described above, the power controller 120 controls the turning ON/OFF of the switching element 183 to control the connection between the commercial power supply 30 and each of the first low-voltage power supply 184 and the second low-voltage power supply 185. In FIG. 4, the control is illustrated by arrows connecting the power controller 120 and the first low-voltage power supply 184 and the second low-voltage power supply 185.

Moreover, it is assumed that the image forming apparatus 10 operates in the sleep-zero mode at the time point at which the process described later starts. That is, the image forming apparatus 10 is in a state in which the pyroelectric sensor 130, a portion of the main controller 110, and the power controller 120 only are operated using the power storage device 170 as a power supply. On the other hand, the switching element 183 is turned off, and the first low-voltage power supply 184 and the second low-voltage power supply 185 are disconnected from the commercial power supply 30. In this case, it can be said that the power consumption of the image forming apparatus 10 based on the commercial power supply 30 is zero.

In the sleep-zero mode, the image forming apparatus 10 detects whether a person is present in the first detection range F with the aid of the pyroelectric sensor 130. As illustrated in FIG. 5A, when a person H enters into the first detection range F, the pyroelectric sensor 130 supplies a detection signal indicating the entrance to the power controller 120 (step S1).

When the detection signal is supplied from the pyroelectric sensor 130, the power controller 120 turns the switching element 183 on so that the commercial power supply 30 is connected to the first low-voltage power supply 184 (step S2). By the process of step S2, the image forming apparatus 10 transitions from the sleep-zero mode to the sleep mode. When the sleep mode starts, the first low-voltage power supply 184 supplies electric power to the main controller 110, the power controller 120, the pyroelectric sensor 130, and the reflection sensor 140 via the rectifying element D2 based on the commercial power supply 30. The reflection sensor 140 receives the electric power from the first low-voltage power supply 184 and starts detecting the presence of a person in the second detection range R according to an instruction (step S3) from the power controller 120.

When the supply of electric power by the first low-voltage power supply 184 starts (that is, when the sleep mode starts), the power controller 120 supplies an interrupt instruction signal instructing the power storage device 170 to interrupt the supply of electric power to the power storage device 170 (step S4). When the interrupt instruction signal is supplied, the power storage device 170 stops the supply of electric power.

The process of step S4 may be performed after the start of the supply of electric power by the first low-voltage power supply 184 is checked and may be performed after a predetermined period has elapsed from the process of step S2.

Subsequently, as illustrated in FIG. 5B, it is assumed that the person H enters into the second detection range R. The reflection sensor 140 supplies a detection signal indicating the entrance to the power controller 120 and the CPU 111 of the main controller 110 (steps S5 and S6). When the detection signal is supplied from the reflection sensor 140, the CPU 111 operates by receiving the supply of electric power from the first low-voltage power supply 184. Further, the communication unit 113 also operates by receiving the supply of electric power from the first low-voltage power supply 184. That is, the communication unit 113 activates the monitoring function of the communication line 50 and transmits and received data via the communication line 50.

When the detection signal is supplied from the reflection sensor 140, the power controller 120 turns the switching element 183 on so that the commercial power supply 30 is connected to the second low-voltage power supply 185 (step S7). With the process of step S7, the second low-voltage power supply 185 starts the supply of electric power to the user interface 150 and the image forming unit 160 (steps S8 and S9). The user interface 150 and the image forming unit 160 operate by receiving the supply of electric power from the second low-voltage power supply 185. Specifically, the operating unit 151 starts receiving the operations of a user. The display 152 starts displaying an image (for instance, a menu screen) for receiving the user's operation. The image forming unit 160 enters a state in which the image forming process can be executed.

With the above-described process, all hardware circuits illustrated in FIG. 2, of the image forming apparatus 10 operate whereby the image forming apparatus 10 transitions from the sleep mode to the standby mode. In order to start receiving the operation of the user, the image forming apparatus 10 may be configured to make the image forming unit 160 to be in a state of power saving at this time and to return it to a normal operation mode later by the main controller 110, for example.

As illustrated in FIG. 5C, it is assumed that a person H (that is, a user) standing in front of the image forming apparatus 10 operates the operating unit 151 of the user interface 150 to instruct execution of the image forming process. In this case, the person H inputs authentication information such as an ID and a password and designates a storage location of image data used in the image forming process. Moreover, the user may designate the image data used to form an image.

The user authentication may be realized by other authentication method such as ID-card-based authentication or face-recognition-based authentication. The CPU 111 of the main controller 110 may specify the storage location based on an explicit indication of the storage location (for instance, a file path) and may specify a storage location designated in advance for the users who have been authenticated.

Next, upon receiving the instruction to execute the image forming process according to the operation on the operating unit 151 input by the person H (step S10), the CPU 111 transitions the mode of the image forming apparatus 10 from the standby mode to the process execution mode. The CPU 111 requests acquisition of the image data to the storage device 20 through the communication unit 113, based on the instruction received in step S10 (step S11). In this case, the CPU 111 may transmit data (for instance, a file path) indicating the storage location to the storage device 20 and may transmit data for specifying the authenticated user. In the latter case, the storage device 20 specifies the storage location designated in advance for the user. Moreover, the CPU 111 acquires (receives) the image data transmitted from the storage device 20 according to the request of step S11 through the communication unit 113 (step S12). That is, the CPU 111 is an instance of an acquiring unit.

Next, the CPU 111 executes the image forming process in the image forming unit 160, based on the image data acquired from the storage device 20 (step S13). The image forming unit 160 generates raster data by selecting the image data supplied from the CPU 111, and forms an image indicating the raster data on a medium. Processes of step S10 to S13 may be processes similar to a well-know pull print.

In the image forming apparatus 10, when the image forming process is completed, the mode transitions from the process execution mode to the standby mode. The image forming apparatus 10 receives instruction of the user through the user interface 150 in the standby mode, and executes the image forming process through processes of steps S10 to S14.

Subsequently, as illustrated in FIG. 6, a case in which the person H exits the second detection range R because the person has finished using the image forming apparatus 10 will be considered. In this case, the reflection sensor 140 supplies a non-detection signal indicating that the presence of the person H is not detected due to the exiting to the main controller 110 (step S14). When the non-detection signal is supplied from the reflection sensor 140, the CPU 111 supplies a transition instruction signal for instructing the transition to the sleep mode to the user interface 150 and the image forming unit 160 after the elapse of a predetermined period such as a sleep transition period (steps S15 and S16). In response to the transition instruction signal, the user interface 150 and the image forming unit 160 stop their operation.

Subsequently, the CPU 111 supplies a transition instruction signal for instructing the transition to the sleep mode to the power controller 120 (step S17). When the transition instruction signal is supplied, the power controller 120 turns the switching element 183 off so that the commercial power supply 30 is disconnected from the second low-voltage power supply 185 (step S18). With the process of step S18, the second low-voltage power supply 185 interrupts the supply of electric power to the user interface 150 and the image forming unit 160. With the processes of steps S15 to S18, the image forming apparatus 10 transitions from the standby mode to the sleep mode.

Subsequently, the power controller 120 supplies a start instruction signal for causing the power storage device 170 to start the supply of electric power to the power storage device 170 (step S19). When the start instruction signal is supplied, the power storage device 170 starts supplying electric power to the power controller 120, a portion of the main controller 110, and the pyroelectric sensor 130.

Subsequently, the power controller 120 turns the switching element 183 off so that the commercial power supply 30 is disconnected from the first low-voltage power supply 184 (step S20). The process of step S20 may be performed after the start of the supply of electric power by the power storage device 170 is checked and may be performed after a predetermined period has elapsed from the process of step S19.

Moreover, the first low-voltage power supply 184 stops the supply of electric power to the main controller 110, the power controller 120, and the reflection sensor 140. Thus, the image forming apparatus 10 transitions from the sleep mode to the sleep-zero mode. The reflection sensor 140 may be configured so that the supply of electric power thereto is stopped by a switching element such as the power controller 120.

As described above, the power storage device 170 is used a power supply for implementing the operation for transition from the sleep-zero mode to the sleep mode. Specifically, the power storage device 170 may supply the power to operate the pyroelectric sensor 130, a part of the main controller 110, and the power controller 120, and may not supply the power to the hardware circuit such as the reflection sensor 140 which is relatively large in power consumption. In the sleep-zero mode and the sleep mode, a monitoring function of the communication line 50 of the communication unit 113 is also stopped, and thus an increase in power due to the response to the communication line 50 or a remote access from the outside is suppressed as well as the average power consumption. For this reason, the supply power of the power storage device 170 is reduced, and thus the increase in capacity or size of the power storage device 170 is suppressed.

In the image forming apparatus 10, the presence of the person is detected by the pyroelectric sensor 130 and the power is switched from the power storage device 170 to the commercial power supply 30 with the transition from the sleep-zero mode to the sleep mode. Therefore, when the presence of the person is detected by the reflection sensor 140, since the power is switched to the commercial power supply 30, the operation of the main controller 110 and the start of the image display in the user interface 150 become also faster. Thus, the increase in standby time when the user instructs the process execution using the user interface 150 is suppressed.

The invention may be embodied in different forms from the above-described exemplary embodiment. Moreover, the modifications illustrated below may be combined with each other.

The hardware configuration and the functional configuration of the image forming apparatus 10 described hereinabove are instances only.

Moreover, the image forming apparatus 10 may not include the power storage device 170. For instance, the image forming apparatus 10 may operate by receiving the supply of electric power from a photovoltaic panel in the sleep-zero mode. Moreover, the power storage device 170 may be charged from a photovoltaic panel instead of being charged by the low-voltage power supply and the like. The image forming apparatus 10 may operate by receiving the supply of electric power from another power storage device (for instance, a power storage device having a larger capacity than the power storage device 170) different from the power storage device 170 rather than the commercial power supply in the standby mode and the process execution mode.

The type and the number of modes in the above-described exemplary embodiment are instances only. Moreover, the above-described sensor is an instance only and sensors of other types may be used. For instance, an image capturing element for use of recognizing the user based on an image recognition method may be used instead of the reflection sensor 140.

Moreover, the switching from the sleep-zero mode to the standby mode may be realized according to conditions (for instance, an operation of an energy-saving release button) other than the approach of a person to the image forming apparatus 10.

In the above-described exemplary embodiment, although the image forming apparatus 10 is a console-type apparatus, the image forming apparatus 10 may be a desktop apparatus, for instance.

The information processing apparatus of the invention may be an information processing apparatus other than the image forming apparatus, and, for instance, may be an information processing apparatus such as a scanner, a copier, or a facsimile and may be an information processing apparatus such as a personal

computer or a server apparatus.

The respective functions realized by the image forming apparatus 10 of the above-described exemplary embodiments may be realized by one or plural hardware circuits, may be realized by an arithmetic device executing one or plural programs, or may be realized by a combination thereof. When the functions of the image forming apparatus 10 are realized using a program, the program may be provided in the state of being stored in a computer readable recording medium such as a magnetic recording medium (a magnetic tape, a magnetic disk (a hard disk drive (HDD) or a flexible disk (FD)) or the like), an optical recording medium (an optical disc or the like), a magneto-optical recording medium, or a semiconductor memory, or may be delivered via a network. Further, the invention may also be understood as an information processing method performed by a computer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a communication unit that receives supply of electric power and performs communication with a storage device through a communication line, the storage device being used to store data;
a supply controller that controls supply of electric power in an own apparatus according to a plurality of modes including a first mode and a second mode in which power consumption is smaller than that of the first mode, and transitions from the second mode, in which the supply of electric power to the communication unit is interrupted, to the first mode in which electric power is supplied to the communication unit;
a receiving unit that receives instruction to execute process based on the data from a user after the transition from the second mode to the first mode;
an acquiring unit that requests acquisition of the data to the storage device and acquires the data according to the request based on the instruction; and
an execution unit that executes a process based on the acquired data.

2. The information processing apparatus according to claim 1,
wherein the plurality of modes further includes a third mode in which power consumption is greater than that of the second mode but is smaller than that of the first mode,
wherein the information processing apparatus further comprises:
a first detector that detects a presence of a person within a first distance during the second mode; and
a second detector that detects a presence of a person within a second distance shorter than the first distance during the third mode,
wherein the supply controller supplies electric power to the first detector based on a first power supply during the second mode,
wherein the supply controller transitions to the third mode and supplies electric power to the second detector by switching from the first power supply to a second power supply when the presence of the person is detected within the first distance, and
wherein the supply controller transitions to the first mode when the presence of the person is detected within the second distance.

3. The information processing apparatus according to claim 2, further comprising:
a display that displays an image used for reception of the instruction by receiving the supply of electric power,
wherein the supply controller supplies electric power to the display based on the second power supply, in a case of the transition to the first mode.

4. The information processing apparatus according to claim 2,
wherein the first power supply is a power storage device, and
wherein the second power supply supplies electric power based on a commercial power supply.

5. The information processing apparatus according to claim 2,
wherein the first detector comprises a pyroelectric sensor, and
wherein the second detector comprises a reflection sensor that consumes a larger amount of power than the pyroelectric sensor.

6. The information processing apparatus according to claim 2, wherein the supply controller stops the supply of electric power to the second detector while supplying electric power to the first detector during the second mode.

7. A non-transitory computer readable medium storing a program causing a computer of an information processing apparatus to execute a process, the information processing apparatus comprising a communication unit that receives the supply of electric power and performs communication with a storage device used to store data through a communication line, the process comprising:
controlling supply of electric power in an own apparatus according to a plurality of modes including a first mode and a second mode in which power consumption is smaller than that of the first mode, and transitioning from the second mode, in which the supply of electric power to the communication unit is interrupted, to the first mode in which electric power is supplied to the communication unit;
receiving instruction to execute process based on the data from a user after the transition from the second mode to the first mode;
requesting acquisition of the data to the storage device and acquiring the data according to the request based on the instruction; and
executing a process based on the acquired data.

8. An information processing method for an information processing apparatus, the information processing apparatus comprising a communication unit that receives the supply of electric power and performs communication with a storage device used to store data through a communication line, the method comprising:
controlling supply of electric power in an own apparatus according to a plurality of modes including a first mode and a second mode in which power consumption is smaller than that of the first mode, and transitioning from the second mode, in which the supply of electric power to the communication unit is interrupted, to the first mode in which electric power is supplied to the communication unit;
receiving instruction to execute process based on the data from a user after the transition from the second mode to the first mode;
requesting acquisition of the data to the storage device and acquiring the data according to the request based on the instruction; and
executing a process based on the acquired data.
